(19) United States
(12) Patent Application Publication
(10) Pub. No.: US 2025/0360816 A1
(43) Pub. Date: Nov. 27, 2025

(54) VEHICLE CHARGE PORT ASSEMBLY

(71) Applicant: NISSAN NORTH AMERICA, INC., Franklin, TN (US)

(72) Inventors: Jeremy CHAMBERS, Casco, MI (US); Jammeh ANSU, Brighton, MI (US); Mallori KAY, Howell, MI (US); Jeffrey TESSMER, Novi, MI (US); Voltaire KENDRICK, Belleville, MI (US)

(21) Appl. No.: 18/673,026

(22) Filed: May 23, 2024

(51) Int. Cl. B60L 53/16

(52) U.S. Cl. CPC B60L 53/16

(57) ABSTRACT

A vehicle charge port assembly includes an alternating current charge port, and a direct current charge port. The direct current charge port includes a first pin socket, a second pin socket, and an opening disposed between the first pin socket and the second pin socket. An insert is removably disposed in the opening.

### BACKGROUND

### Technical Field

The present disclosure generally relates to a vehicle charge port assembly.

### Background Information

Vehicle charge port assemblies of an electric vehicle are configured to be compatible with a specific charging system, such as the Combined Charging System (CCS) or the North American Charging Standard (NACS). The vehicle charge port assembly can receive an adapter such that the electric vehicle can utilize a different charging network, such as a CCS connector charging with the NACS system. The adapter allows the electric vehicle to charge at charging stations using the connector of the charge port of the electric vehicle and at charging stations using the configuration of the adapter.

### SUMMARY

A need exists for a vehicle charge port assembly of an electric vehicle configured to receive an adapter to increase charging availability.

In view of the state of the known technology, one aspect of the present disclosure is to provide a vehicle charge port assembly including an alternating current charge port, and a direct current charge port. The direct current charge port includes a first pin socket, a second pin socket, and an opening disposed between the first pin socket and the second pin socket. An insert is removably disposed in the opening.

Another aspect of the present disclosure is to provide a vehicle charge port assembly including an alternating current charge port and a direct current charge port. The direct current charge port includes a first pin socket, a second pin socket, a drain configured to discharge water, and an opening disposed between the first pin socket and the second pin socket. The opening is in fluid communication with the drain.

Also other objects, features, aspects and advantages of the disclosed vehicle charge port assembly will become apparent to those skilled in the art from the following detailed description, which, taken in conjunction with the annexed drawings, discloses exemplary embodiments of a vehicle charge port assembly.

### BRIEF DESCRIPTION OF THE DRAWINGS

Referring now to the attached drawings which form a part of this original disclosure:

FIG. 1 is a perspective view of a vehicle charge port in accordance with an exemplary embodiment;

FIG. 2 is a front elevational view of a conventional adapter;

FIG. 3 is an elevational view in cross-section of the conventional adapter of FIG. 2;

FIG. 4 is a perspective view of the vehicle charge port of FIG. 1;

FIG. 5 is a perspective view of the vehicle charge port assembly in which the vehicle charge port of FIG. 1 receives an insert;

FIG. 6 is a perspective view in cross-section of the vehicle charge port assembly of FIG. 5 illustrating a drain path;

FIG. 7 is a perspective view in cross-section of the vehicle charge port assembly of FIG. 5;

FIG. 8 is a front perspective view of the insert of FIG. 5;

FIG. 9 is a rear perspective view of the insert of FIG. 8;

FIG. 10 is a lower perspective view of the insert of FIG. 5;

FIG. 11 is a front perspective view of an insert in accordance with another exemplary embodiment;

FIG. 12 is a rear perspective view of the insert of FIG. 11;

FIG. 13 is a side perspective view of an insert in accordance with another exemplary embodiment;

FIG. 14 is a rear perspective view of the insert of FIG. 13;

FIG. 15 is a front perspective view of an insert in accordance with another exemplary embodiment;

FIG. 16 is a rear perspective view of the insert of FIG. 15;

FIG. 17 is a rear perspective view of an insert in accordance with another exemplary embodiment;

FIG. 18 is a front perspective view of an insert in accordance with another exemplary embodiment; and

FIG. 19 is a perspective view of a vehicle charge port assembly in accordance with another exemplary embodiment in which an insert fills an entirety of a gap.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

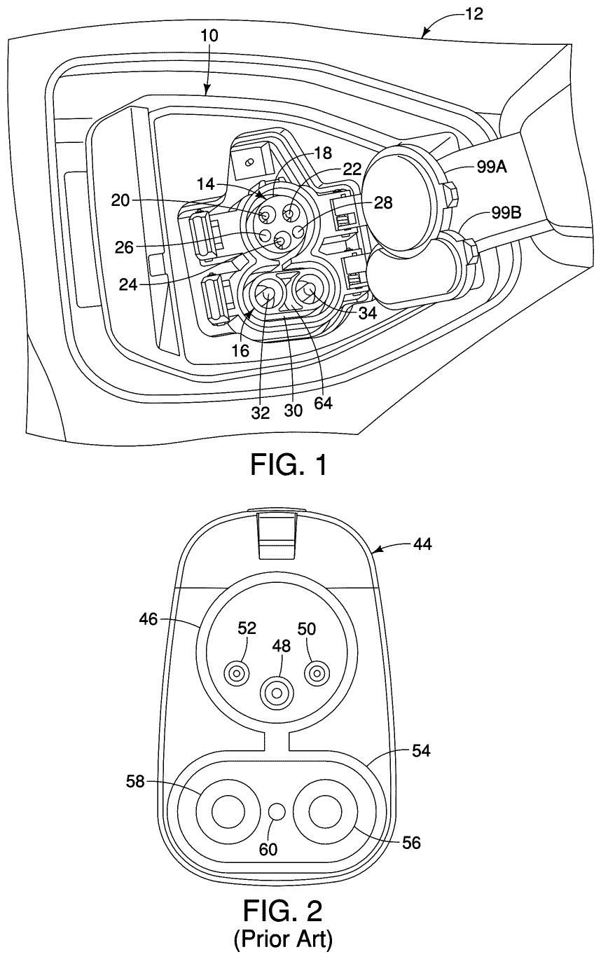

Referring initially to FIGS. 1 and 4-10, a vehicle charge port assembly 10 of an electric vehicle 12 is illustrated in accordance with a first exemplary embodiment. The vehicle charge port assembly 10 includes an AC (alternating current) charge port 14 and a DC (direct current charge port) 16. The AC charge port 15 and the DC charge port 16 are connected to a battery of the electric vehicle 12 in a conventional manner to supply power from a charging station to the battery during a charging operation.

The AC charge port 14 can have a conventional SAE J1772 type 1 configuration including five pins disposed in a housing 18. Each of the five pins has a different function. A first pin 20 carries a primary voltage supply. A second pin 22 completes the AC circuit. A third pin 24 ensures the charging process is grounded. A fourth pin 26 enables communication between charging station and the electric vehicle 12. A fifth pin 28 regulates and controls the charging process. When the AC charge port 14 receives a plug from a charging station, the electric vehicle 12 is configured to be charged with AC power received from the charging station. The electric vehicle 12 includes an on-board charger configured to convert the AC power to DC power to charge the vehicle battery. The DC charge port 16 is not utilized when charging with AC power.

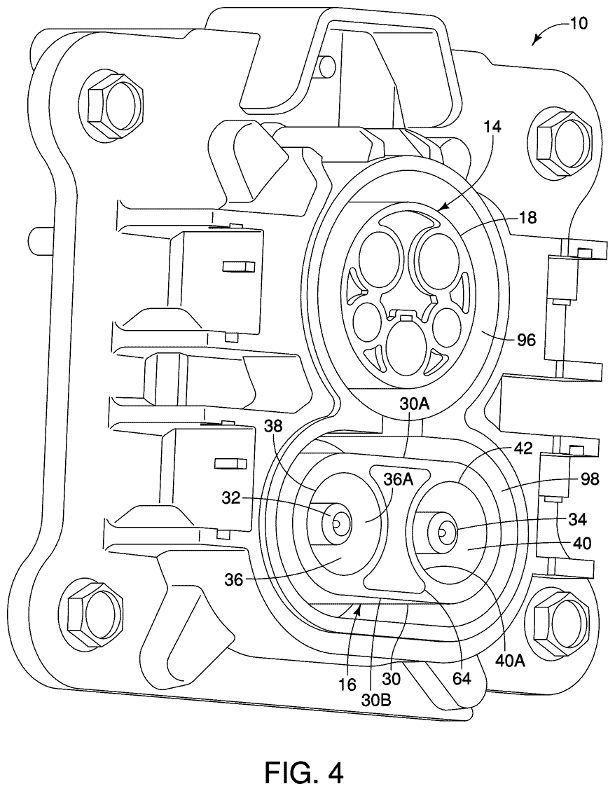

The DC charge port 16 includes a housing 30 including a first pin 32 and a second pin 34, as shown in FIGS. 1 and 4. The first pin 32 is a DC+ pin for positive direct current. The second pin is a DC-pin for negative direct current. A first receiving area 36 is formed around the first pin 32 to define a first pin socket 38. A second receiving area 40 is formed around the second pin 34 to define a second pin socket 42. When the vehicle charge port assembly 10 receives a plug from the charging station configured to charge the electric vehicle 10 with direct current, the plug utilizes the third pin 24, the fourth pin 26 and the fifth pin 28 of the AC charge port 14 and the first pin 32 and the second pin 34 of the DC charge port 16 to deliver DC power. AC power is converted to DC power by the charging station, such that the charging station supplies DC power directly to the battery of the electric vehicle 10, thereby allowing the electric vehicle to charge quickly.

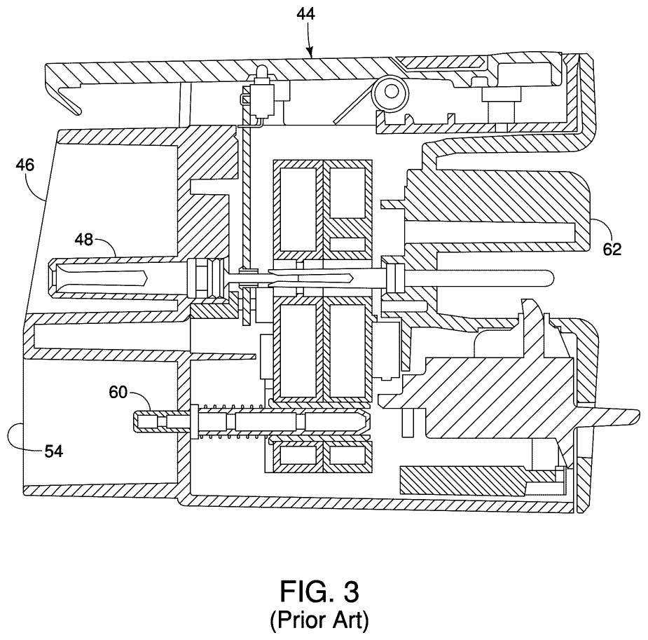

A conventional adapter 44, as shown in FIGS. 2 and 3, is configured to allow an electric vehicle with a CCS1 charging port to charge at an NACS charging station. The adapter 44 includes an AC charge port 46, which includes a first plug 46, a second plug 48 and a third plug 50. The first plug 48 is configured to engage the third pin 24 of the AC charge port 14 of the vehicle charge port assembly 10. The second plug 50 is configured to engage the fourth pin 26 of the AC charge port 14. The third plug 52 is configured to engage the fifth pin 28 of the AC charge port 14.

The adapter 44 includes a DC charge port 54 including a first plug 56, a second plug 58 and a locking pin 60. The first plug 56 is configured to engage the first pin 32 of the DC charge port 16 of the vehicle charge port assembly 10. The second plug 58 is configured to engage the second pin 34 of the DC charge port 16.

A rear surface 62 of the adapter 44 is configured to receive a charging cable from the charging station. The locking pin 60 is configured to engage a surface of the vehicle charge port assembly 10 upon connecting the adapter 44 to the vehicle charge port assembly 10 to allow DC power to be transmitted from the charging station to the vehicle charge port assembly 10 of the electric vehicle 12. When the locking pin 60 does not engage a surface of the vehicle charge port assembly 10, power is prevented from being transmitted from the charging station to the vehicle charge port assembly 10.

The housing 30 of the DC charge port 16 includes an opening 64 disposed between the first pin socket 36 and the second pin socket 40, as shown in FIGS. 1, 4 and 5. The opening 64 is defined by an upper wall 30A of the housing 30, a lower wall 30B of the housing 30, a wall 36A of the first pin socket 36, and a wall 40A of the second pin socket 40, as shown in FIG. 4. The walls 36A and 40A of the first and second pin sockets 36 and 40 are substantially cylindrical such that the portions of the walls 36A and 40A defining the opening 64 provide the opening 64 with concave side walls extending between the upper and lower walls of the opening 64.

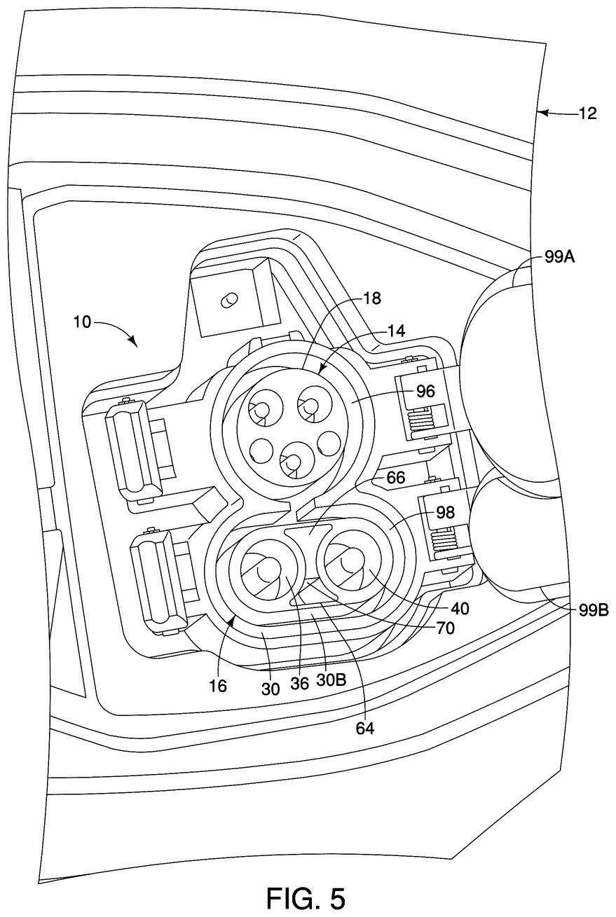

An insert 66 is disposed in the opening 64, as shown in FIG. 5, to provide a surface configured to be engaged by the locking pin 60 of the adapter 44 when connecting the adapter to the vehicle charge port assembly 10. The insert 66 is preferably removably disposed in the opening 64. In other words, a portion, i.e., the insert 66, of the DC charge port 16 above the opening 64 is removable. The insert 66 has a shape substantially corresponding to the shape of the opening 64.

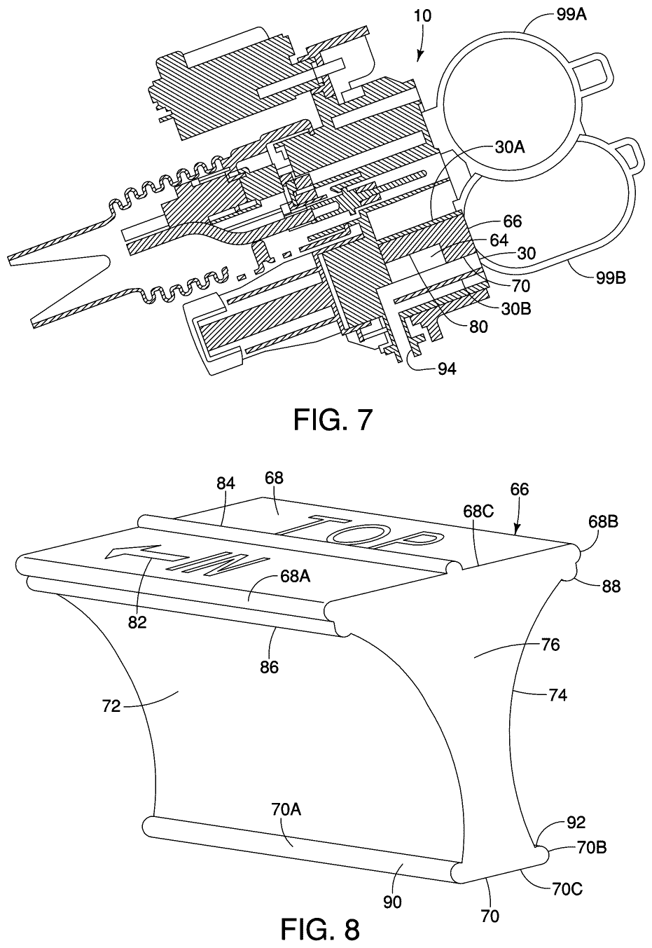

The insert 66, as shown in FIGS. 7-10, includes an upper surface 68 and a lower surface 70. A first concave side surface 72 connects the upper surface 68 and the lower surface 70. The first concave side surface 72 extends between a first longitudinal edge 68A of the upper surface 68 and a first longitudinal edge 70A of the lower surface 70. A second concave side surface 74 connects the upper surface 68 and the lower surface 70. The second concave side surface 74 extends between a second longitudinal edge 68B of the upper surface 68 and a second longitudinal edge 70B of the lower surface 70. The first and second longitudinal edges 68A and 68B of the upper surface 68 are substantially parallel. The first and second longitudinal edges 70A and 70B of the lower surface 70 are substantially parallel.

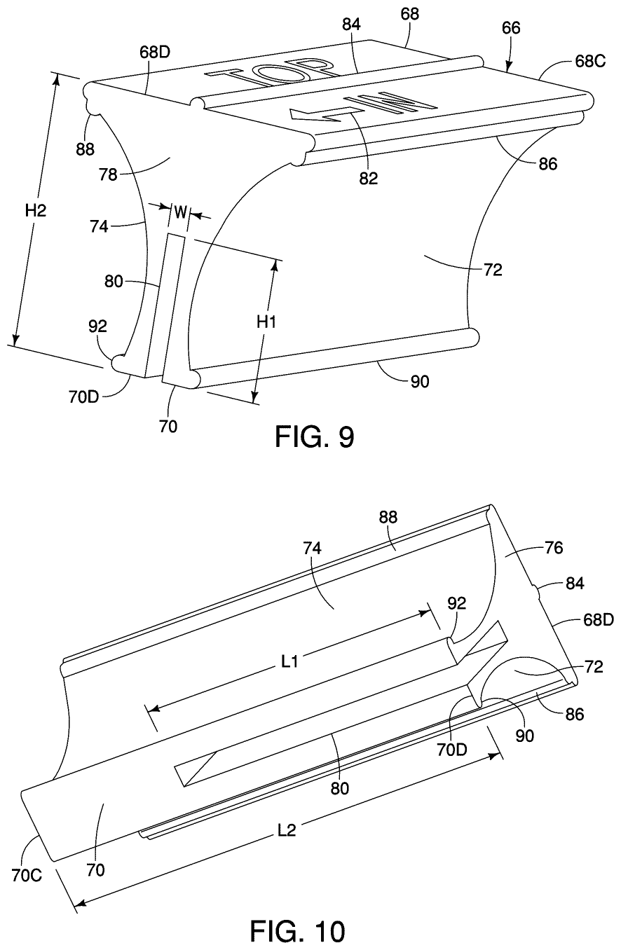

A front surface 76 extends from a first laterally extending edge 68C of the upper surface 68 to a first laterally extending edge 70C of the lower surface 70, as shown in FIG. 8. A rear surface 78 extends from a second laterally extending edge 68D of the upper surface 68 to a second laterally extending edge 70D of the lower surface 70, as shown in FIGS. 9 and 10. The first laterally extending edge 68C and the second laterally extending edge 68D of the upper surface 68 are substantially parallel. The first laterally extending edge 70C and the second laterally extending edge 70D of the lower surface 70 are substantially parallel.

A slot 80 is formed in the lower surface 68 of the insert 66, as shown in FIGS. 7, 9 and 10. The slot 80 extends from the second laterally extending edge 70D, or a rear end, of the lower surface 70 toward the first laterally extending edge 70C, or front end of the lower surface 70. A first length L1 of the slot 80 is less than a second length L2 of the lower surface 70. A first height H1 of the slot 80 is less than a second height H2 of the rear surface 78. The slot 80 preferably has a substantially constant width W and a substantially constant height along the entire length of the slot 80.

An indication 82 is provided on the insert 66 to facilitate insertion of the insert 66 in the opening 64 in the housing 30 of the vehicle charge port assembly 10, as shown in FIGS. 8 and 9. The indication 82 can include an arrow indicating an insertion direction of the insert 66. The indication 82 can include a description indicating the insertion direction of the insert 66. The indication 82 can include a description indicating a top of the insert 66 during insertion of the insert 66.

A first rib 84 projects upwardly from the upper surface 68 of the insert 66, as shown in FIGS. 8 and 9. The first rib 84 preferably extends from the first laterally extending edge 68C to the second laterally extending edge 68D of the upper surface 68. A second rib 86 projects outwardly from the first concave side surface 72 of the insert 66. A third rib 88 projects outwardly from the second concave side surface 74 of the insert 66. The second rib 86 and the third rib 88 preferably extend from the front surface 76 to the rear surface 78 of the insert 66. A fourth rib 90 projects outwardly from the first concave side surface 72 of the insert 66. A fifth rib 92 projects outwardly from the second concave side surface 74 of the insert 66. The fourth rib 90 and the fifth rib 92 preferably extend from the front surface 76 to the rear surface 78 of the insert 66. The second and third ribs 86 and 88 are preferably disposed proximate the upper surface 68. The fourth and fifth ribs 90 and 92 are preferably disposed proximate the lower surface 70. The first to fifth ribs engage the wall defining the opening 64 when the insert 66 is inserted in the opening 64 to facilitate securely retaining the insert 66 within the opening 64, such as by creating a friction fit with the housing 30. The slot 80 is configured to receive a tool to facilitate removing the insert 66 from the opening 66.

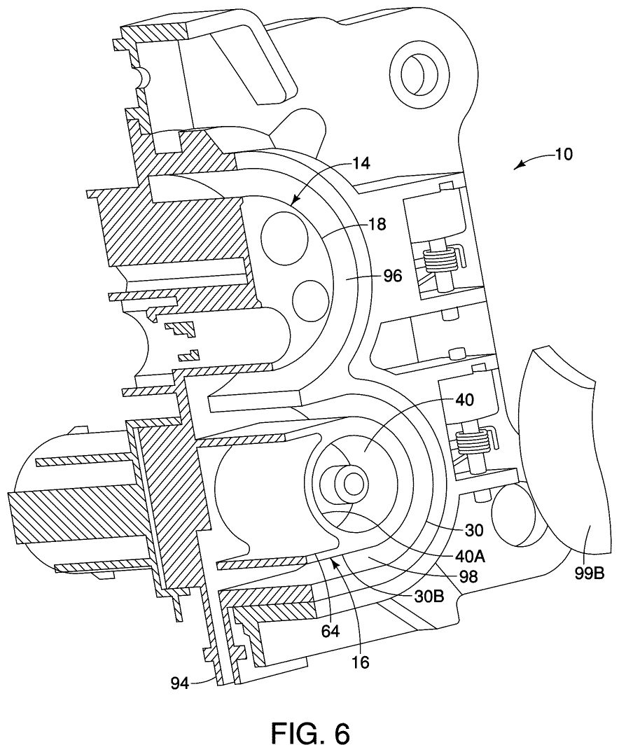

The DC charge port 16 includes a drain 94 configured to discharge water from the DC charge port 16, as shown in FIGS. 6 and 7. The opening 64 is in fluid communication with the drain 94. A first space 96 surrounding the housing 18 of the AC charge port 14 and a second space 98 surrounding the housing 30 of the DC charge port 16 is in fluid communication with the drain 94. As shown in FIG. 6, water that collects in the first and second spaces 96 and 98 flows to a portion of the second space 98 beneath the lower wall 30B of the housing 30. The water flows rearwardly toward the drain 94 provided at a rear end of the housing 30. Water collecting in the opening 64 flows rearwardly toward the drain 94 provided at the rear end of the opening 64. The lower surface 74 of the insert 66 is spaced from the lower wall 30B of the housing 30, as shown in FIGS. 5 and 7, to facilitate draining water in the opening 64 of the DC charge port 16 to the drain 94. The height of the insert 66 is approximately two-thirds the height of the opening 64, such that the distance from the lower surface 70 to the lower wall 30B is approximately one-third of the height of the opening 64, although the insert 66 can have any suitable height providing a space between the lower surface 70 and the lower wall 30B.

A first cover 99A is movably connected to the vehicle charge port assembly 10 to cover the AC charge port 14 when not in use. A second cover 99B is movably connected to the vehicle charge port assembly 10 to cover the DC charge port 16 when not in use.

The insert 66 is inserted in the opening 64 between the first pin socket 36 and the second pin socket 40 of the DC charge port 16 to provide a surface configured to engage the locking pin 60 of the adapter 44. In other words, the locking pin 60 of the adapter 44 is configured to engage the front surface 76 of the insert 66 when the insert 66 is disposed in the opening 64 in the housing 30 of the DC charge port 16 and the adapter 44 is connected to the vehicle charge port assembly 10.

The insert 66 is preferably integrally formed as a one-piece member. The insert 66 is made of any suitable material, such as a nylon material, which provides durability to conditions face by the insert, such as heat, cold, vibration and pressure.

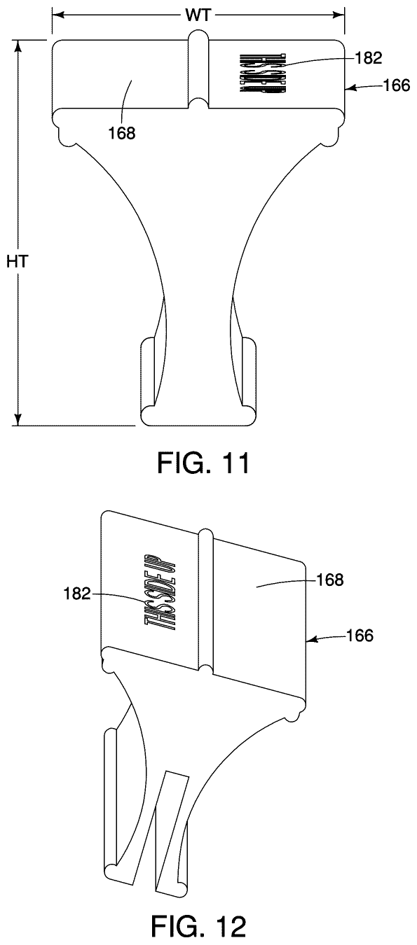

As shown in FIGS. 11-12, an insert 166 in accordance with another illustrated exemplary embodiment of the present invention is substantially similar to the insert 66 of the vehicle charge port assembly 10 of the exemplary embodiment illustrated in FIGS. 5 and 7-10 except for the differences described below. Similar parts are identified with similar reference numerals, except increased by 100 (i.e., 1xx, accordingly).

The insert 166 is substantially similar to the insert 66 of FIGS. 5 and 7-10, except that an overall height HT and overall width WT of the insert 166 is larger than the overall height and width of the insert 66. The height HT and width WT of the insert 166 can have any suitable dimensions larger than the height and width of the insert 66, such as a two percent increase in each of the height and the width of the insert 166. The increased height and width of the insert 166 facilitates creating a friction fit when inserting the insert 166 in the opening in the DC charge port. The indicia 182 provided on the upper surface 168 of the insert 166 can be different from the indicia 82 provided on the upper surface 68 of the insert 66. The indicia 182 provides an indication facilitating insertion of the insert 166, such as which surface is the upper surface when inserting the insert 166 in the opening 64 of the DC charge port 16 (FIG. 5).

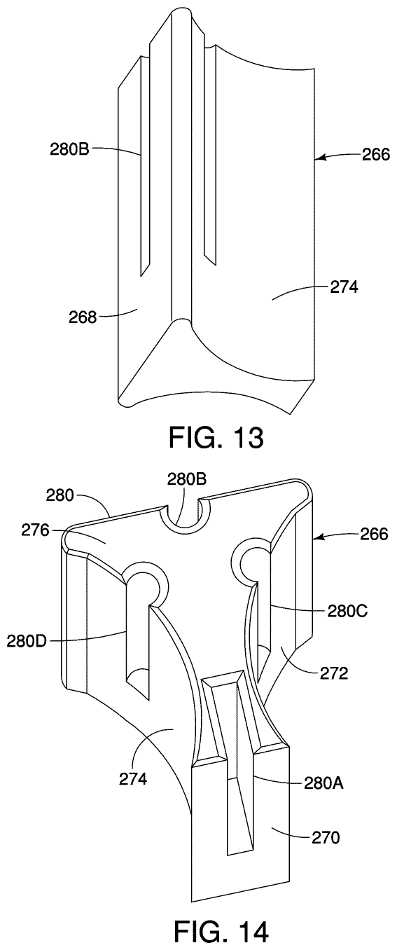

As shown in FIGS. 13-14, an insert 266 in accordance with another illustrated exemplary embodiment of the present invention is substantially similar to the insert 66 of the vehicle charge port assembly 10 of the exemplary embodiment illustrated in FIGS. 5 and 7-10 except for the differences described below. Similar parts are identified with similar reference numerals, except increased by 200 (i.e., 2xx, accordingly).

The insert 266 is substantially similar to the insert 66 of FIGS. 5 and 7-10, except that the insert 266 includes a plurality of slots 280, as shown in FIGS. 13 and 14. A first slot 280A is disposed in the lower surface 270. A second slot 280B is disposed in the upper surface 268. A third slot 280C is disposed in the first concave side surface 272. A fourth slot 280D is disposed in the second side surface 274. Each of the first slot 280A, the second slot 280B, the third slot 280C, and the fourth slot 280D has a length less than a length of the insert 266. Each of the first slot 280A, the second slot 280B, the third slot 280C, and the fourth slot 280D extends from the rear surface 276, or rear end, of the insert 266. Preferably, each of the first slot 280A, the second slot 280B, the third slot 280C, and the fourth slot 280D has a substantially similar length, although the lengths can be different.

The first slot 280A is configured to receive a tool to facilitate removal of the insert from the opening. Each of the second slot 280B, the third slot 280C and the fourth slot 280D is configured to receive a rubber insert to facilitate creating a friction fit with the walls of the opening.

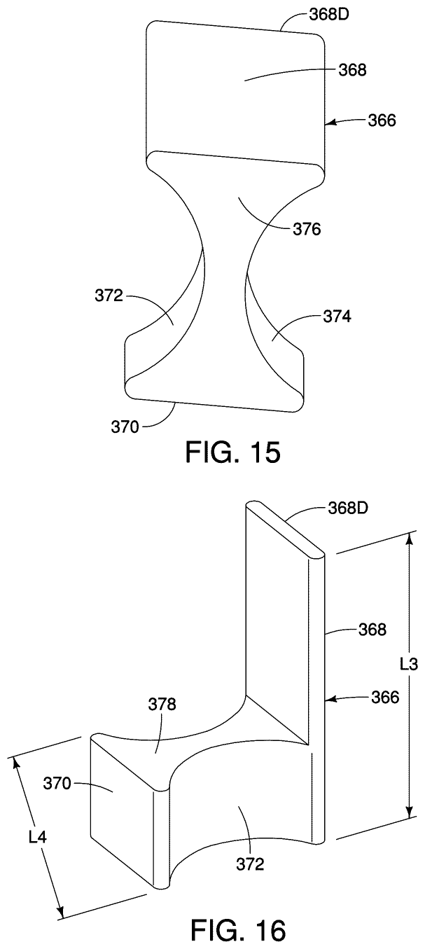

As shown in FIGS. 15-16, an insert 366 in accordance with another illustrated exemplary embodiment of the present invention is substantially similar to the insert 66 of the vehicle charge port assembly 10 of the exemplary embodiment illustrated in FIGS. 5 and 7-10 except for the differences described below. Similar parts are identified with similar reference numerals, except increased by 300 (i.e., 3xx, accordingly).

The upper surface 368 of the insert 366 extends rearwardly further than each of the lower surface 370, the first concave side surface 372 and the second concave side surface 374, as shown in FIGS. 15 and 16. In other words, a length L3 of the upper surface 368 is longer than a length L4 of the lower surface 370. The rear surface 378 extends substantially perpendicularly to the upper surface 368. A rear end 368D of the upper surface 368 is disposed rearward of the rear surface 378.

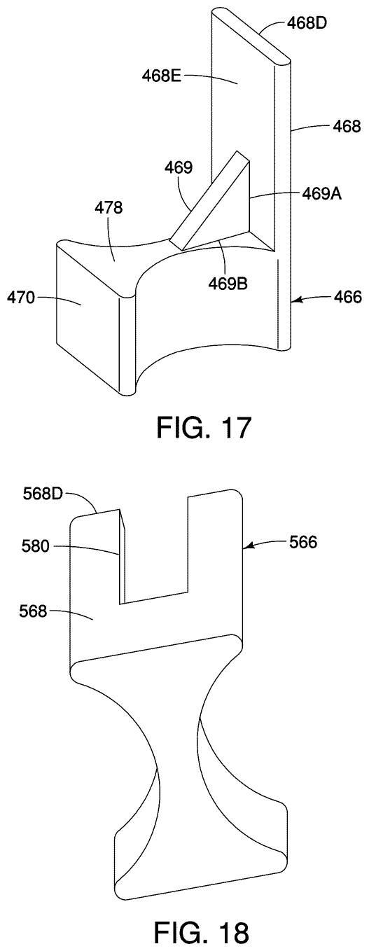

As shown in FIG. 17, an insert 466 in accordance with another illustrated exemplary embodiment of the present invention is substantially similar to the insert 366 of the vehicle charge port assembly of the exemplary embodiment illustrated in FIGS. 15 and 16 except for the differences described below. Similar parts are identified with similar reference numerals, except increased by 100 (i.e., 4xx, accordingly).

A support member 469 extends from the rear surface 478 to a lower portion 468E of the upper surface 468, as shown in FIG. 17. The support member 469 can have any suitable shape, such as triangular. A first surface 469A of the support member 469 engages the lower portion 468E of the upper surface 468. A second surface 469B of the support member 469 engages the rear surface 478. The support member 469 strengthens the insert 466. The rear end 468D of the upper surface 468 is disposed rearward of the support member 469. The lower surface 470 is disposed lower than the support member 469.

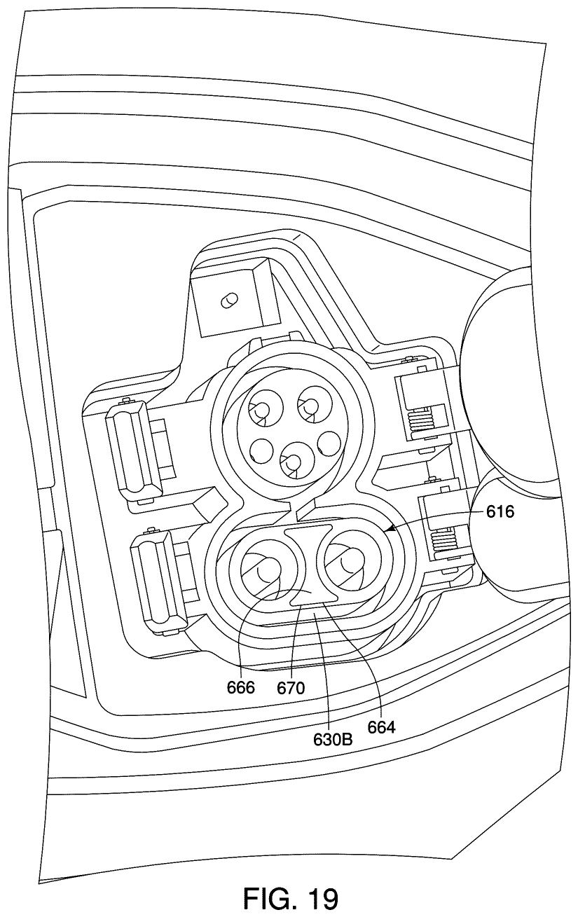

As shown in FIG. 18, an insert 566 in accordance with another illustrated exemplary embodiment of the present invention is substantially similar to the insert 366 of the vehicle charge port assembly of the exemplary embodiment illustrated in FIGS. 15 and 16 except for the differences described below. Similar parts are identified with similar reference numerals, except increased by 200 (i.e., 5xx, accordingly).

A slot 580 extends forwardly from the second laterally extending edge 568D, or the rear end, of the upper surface 568, as shown in FIG. 18. The slot 580 has a length less than a longitudinal length of the upper surface 568. A width of the slot 580 is less than a width of the upper surface 568.

As shown in FIG. 19, an insert 666 in accordance with another illustrated exemplary embodiment of the present invention is substantially similar to the insert 66 of the vehicle charge port assembly 10 of the exemplary embodiment illustrated in FIGS. 5 and 7-10 except for the differences described below. Similar parts are identified with similar reference numerals, except increased by 600 (i.e., 6xx, accordingly).

The insert 666 is removably received in the opening 664 of the DC charge port 616, as shown in FIG. 19. The lower surface 670 of the insert 666 contacts the lower surface 630B of the housing 630 defining the opening 664, as shown in FIG. 19. As shown in FIGS. 6 and 7, water flows through the first and second spaced 96 and 98 of the AC and DC charge ports 14 and 16 to the drain 94 when the opening 664 is substantially filled by the insert 666.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle charge port assembly. Accordingly, these terms, as utilized to describe the present invention should be interpreted relative to a vehicle equipped with the vehicle charge port assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle charge port assembly comprising:
an alternating current charge port; and
a direct current charge port, the direct current charge port including
a first pin socket,
a second pin socket,
an opening disposed between the first pin socket and the second pin socket, and
an insert removably disposed in the opening.

2. The vehicle charge port assembly according to claim 1, wherein
the opening is formed by an upper wall of a housing, a lower wall of a housing, a wall of the first pin socket, and a wall of a second pin socket.

3. The vehicle charge port assembly according to claim 2, wherein
a bottom surface of the insert is spaced from the lower wall.

4. The vehicle charge port assembly according to claim 2, wherein
the bottom surface of the insert contacts the lower wall.

5. The vehicle charge port assembly according to claim 1, wherein
the insert has an upper surface, a lower surface, a first concave side surface connecting the upper surface and the lower surface, and a second concave side surface connecting the upper surface and the lower surface.

6. The vehicle charge port assembly according to claim 5, wherein
a slot is formed in the lower surface of the insert.

7. The vehicle charge port assembly according to claim 6, wherein
the slot extends from a rear end of the lower surface toward a front end of the lower surface.

8. The vehicle charge port assembly according to claim 7, wherein
a length of the slot is less than a length of the lower surface.

9. The vehicle charge port assembly according to claim 5, wherein
a rib projects upwardly from the upper surface of the insert.

10. The vehicle charge port assembly according to claim 5, wherein
a pair of ribs project outwardly from each of the first and second concave side surfaces.

11. The vehicle charge port assembly according to claim 5, wherein
an indication is disposed on the upper surface to facilitate insertion of the insert in the opening of the direct current charge port.

12. The vehicle charge port assembly according to claim 5, wherein
the insert includes a first slot in the lower surface, a second slot in the upper surface, a third slot in the first concave side surface, and a fourth slot in the second concave side surface.

13. The vehicle charge port assembly according to claim 12, wherein
a length of each of the first slot, the second slot, the third slot and the fourth slot is less than a length of the insert.

14. The vehicle charge port assembly according to claim 12, wherein
each of the first slot, the second slot, the third slot and the fourth slot extends from a rear end of the insert.

15. The vehicle charge port assembly according to claim 12, wherein
each of the first slot, the second slot, the third slot and the fourth slot is substantially a same length.

16. The vehicle charge port assembly according to claim 5, wherein
the upper surface extends rearwardly further than each of the lower surface, the first concave side surface, and the second concave side surface.

17. The vehicle charge port assembly according to claim 16, wherein
a support member extends from a rear surface of the insert to a lower portion of the upper surface.

18. The vehicle charge port assembly according to claim 16, wherein
a slot extends forwardly from a rear end of the upper surface.

19. A vehicle charge port assembly comprising:
an alternating current charge port; and
a direct current charge port, the direct current charge port including
a first pin socket,
a second pin socket,
a drain configured to discharge water, and
an opening disposed between the first pin socket and the second pin socket, the opening being in fluid communication with the drain.

20. The vehicle charge port assembly according to claim 19, wherein
a portion of the direct current charge port above the opening is removable.
